(19) United States
(12) Patent Application Publication
(10) Pub. No.: US 2018/0362714 A1
(43) Pub. Date: Dec. 20, 2018

(54) Anti-Microbial Coating Materials

(71) Applicant: California Institute of Technology, Pasadena, CA (US)

(72) Inventors: Robert H. GRUBBS, South Pasadena, CA (US); Choon Woo LEE, La Canada, CA (US)

(21) Appl. No.: 15/985,966

(22) Filed: May 22, 2018

Related U.S. Application Data
(60) Provisional application No. 62/520,697, filed on Jun. 16, 2017.

(51) Int. Cl. C08G 73/02; C09D 179/02

(52) U.S. Cl. CPC C08G 73/0226; C09D 179/02

(57) ABSTRACT

The disclosure provides methods and materials suitable for preparing coating layers on substrates. The coatings comprise quaternary amine groups and therefore impart anti-bacterial properties to the substrate. In one embodiment, for example, there is provided a quaternary amine-containing polymeric coating comprising propylene and ethylene repeat units.

### CROSS REFERENCE TO RELATED APPLICATIONS

This application claims priority to U.S. Patent Application Ser. No. 62/520,697, filed Jun. 16, 2017, the contents of which are incorporated by reference herein in their entirety.

### TECHNICAL FIELD

The present disclosure is directed to materials and methods suitable for providing an object surface with antimicrobial properties. The invention(s) find(s) utility, for example, in the fields of chemistry and surface coatings.

### BACKGROUND

Bacterial infections are common in a variety of circumstances, and are responsible for necessitating a large number of medical interventions each year. Over the past 100 years, numerous antibiotic agents have been developed, with varying levels of efficacy. Unfortunately, primarily due to the misuse of antibiotics, antibiotic-resistant strains of bacteria have become more common recently. As antibiotics become less effective against bacterial infections, avoidance of the infections becomes increasingly important and an increasingly preferable approach.

At present, bacteria can populate most surfaces commonly encountered by individuals. For example, the materials used to prepare door knobs, computer keyboards, touch screens, hand rails, and the like do not typically have anti-bacterial properties, and the spread of bacteria within a population is typically limited only by the precautions taken by individuals. For example, proper hygiene (e.g., frequent hand washing) is a highly effective way to avoid bacterial infections of individuals, but requires active participation by the individual and is therefore not always a reliable method. Frequent cleaning and disinfecting of public surfaces and items that are handled by multiple individuals is not always possible and remains a labor intensive method to minimizing the spread of bacteria. Even under nearly ideal conditions, where individuals are taking all practical precautions to avoid the spread and growth of bacteria, certain environments remain prone to bacterial growth. Examples include surfaces that are routinely exposed to aqueous environments for prolonged periods of time. Such surfaces may require thorough cleaning on a regular basis, and where such cleaning is improper, incomplete, or nonexistent bacterial growth may result.

One approach to preventing the spread bacteria and bacterial infections from exposure to bacterial growth is to provide object surfaces with inherent anti-bacterial activity, such as with a surface coating that imparts such properties. Ideally, such a method would be easily adapted for a variety of object surfaces, would use commonly available and inexpensive materials, would provide long-term anti-bacterial activity with minimal or no toxicity toward animals, and/or would not contribute to the growing incidence of drug-resistant bacteria.

### SUMMARY

The present disclosure is directed to methods for forming antimicrobial surface coatings, the coatings themselves, and articles containing such coatings. The methods allow for simpler and more relaible processing of such coatings, with at least the same efficiacies as previously reported.

Some embodiments comprise methods of forming an anti-microbial surface coating on a substrate, the methods comprising:

a) reacting a polymeric pre-amine material comprising a plurality of the functional groups with a polymeric amine-containing reagent so as to convert at least a portion of the functional groups to amine groups to form a composite polyamine polymer;

b) step-wise reacting the composite polyamine polymer with:
(i) a first alkylating agent, R—X, where R is at least a C6 alkyl, preferably a C₆₋₂₄ alkyl group and X is a leaving group susceptible to nucleophilic displacement, and
(ii) a second alkylating agent that is more active than the first alkylating agent,
so as to convert at least a portion of the amine groups of the composite polyamine polymer to quaternary amine groups, the stepwise reaction resulting in the formation of a mixture of quaternized composite polyamine polymer, often in the presence of quaternized polymeric amine-containing reagent.

In some embodiments, the functional groups of the polymeric pre-amine material are one or more halogens, such that polymeric pre-amine material is a polyhalogenated polymer. Chlorinated polypropylene is an attractive material used in this capacity.

In some embodiments, the polymeric amine-containing reagent is or comprise a poly(ethyleneimine). The poly(ethyleneimine) may be linear or branched, and may contain primary, secondary, and/or tertiary amine groups.

The composite polyamine polymer may contain primary, secondary, and tertiary amine groups, some of these are formed by the displacement of the functional groups of the polymeric pre-amine material by the amine groups of the polymeric amine-containing reagent. The step-wise alkylation by the first and second alkylating agents together serve to increase the alkyl substitution on the amine groups, and thereafter to increase the concentration of the quaternary amine functionality on the composite polyamine polymer. These first and second alkylating are preferably of the form R—X, where R is alkyl, and preferably a linear alkyl, or at least this linearity being present at least proximate to X, and where X is a leaving group susceptible to S_{N}2 nucleophilic displacement. Alkyl halides are suitably used, though X can also be other groups displaceable in S_{N}2 displacement; e.g., mesylate, tosylate, triflate, etc.

The first alkylating agent should have at least 6 carbons in the alkyl chains, to as to maintain the hydrophobicity of the composite polyamine polymer. This reagent may be applied in the presence of a non-nucleophilic base, so as to promote the formation of ternary amines in the composite polyamine polymer.

The quaternized composite polyamine polymer may be used as prepared or it may be purified to remove residual impurities. Such impurities may include, for example, residual or incompletely reacted starting materials or salt by-products. In those circumstances where the polymeric pre-amine material and the polymeric amine-containing reagent do not effectively couple, the resulting alkylating steps can result in the formation of quaternized polymeric amine-containing reagent. In some cases, it is desirable to remove this quaternized polymeric amine-containing reagent from the quaternized composite polyamine polymer. This can be accomplished by washing solid mixtures of these two materials with water and/or lower alcohols, the former quaternized reagent being soluble in such solvents wherein the latter quaternized composite is not.

Whether purified or not, the quaternized composite polyamine polymer may be dissolved in a suitable organic solvent to form a coating solution. This coating solution may be applied to a substrate by any conventional coating means, for example brush coating, dip coating, spin coating, or spray coating. After removing the organic solvent, the substrate is coated with the quaternized composite polyamine polymer. This coating enures antimicrobial activity to the substrate.

Each of these steps or permutations of steps represents individual embodiments of the present disclosure. Likewise, it should be appreciated that the products of each reaction step, either isolated or still in the reaction solution, represent individual embodied compositions.

### BRIEF DESCRIPTION OF THE DRAWINGS

The present application is further understood when read in conjunction with the appended drawings. For the purpose of illustrating the subject matter, there are shown in the drawings exemplary embodiments of the subject matter. However, the presently disclosed subject matter is not limited to the specific methods, devices, and systems disclosed. In addition, the drawings are not necessarily drawn to scale. In the drawings:

FIG. 1 provides a schematic representation of a “heterogeneous” process described in U.S. Pat. No. 8,512,722.

FIG. 2 provides a schematic representation of one embodiment of a “homogeneous” process described in the present application.

FIG. 3 shows an exemplary set of XPS results of polypropylene (PP) coated with quaternized polypropylene (QPP).

FIG. 4 shows an expansion of the XPS results of polypropylene (PP) coated with quaternized polypropylene (QPP) showing the proportion of ternary (30) and quaternary (4°) amine binding energies.

### DETAILED DESCRIPTION OF ILLUSTRATIVE EMBODIMENTS

The present disclosure is directed to methods for forming antimicrobial surface coatings, the coatings themselves, and articles containing such coatings. The methods allow for simpler processing of such coatings, with coatings exhibiting the same or similar efficiacies as previously reported (for example, in U.S. Pat. No. 8,512,722, which is incorporated by reference herein for all purposes, or at least for the methods and materials disclosed throughout therein). In particular, the present compositions and methods provide for coatings which are purer and easier to apply, and so more homogeously applied, than previous reports. As such, the coatings may exhibit even higher efficacies.

While not previously reported as such, the methods described in U.S. Pat. No. 8,512,722 may now be referred to as a heterogeneous coating technology, since the use of short chain alkylating agents promoted in that reference results in coating compositions which were both practically insoluble in water (a desirable characteristic) and poorly soluble even in organic solvents (a less desirable characteristic). Because the amine product (APP: aminated polypropylene) described previously was insoluble in common solvents due to cross-linking and the absence of solubilizing pendants, quaternization of the APP was normally unsuccessful in homogeneous conditions, making handling difficult and the methods difficult to apply in practice.

The present disclosure is the result of very considerable research, and provides coatings and methods that provide for more homogeneous processing to be used. After extensive optimization to overcome an insolubility problem of materials (APP and QPP), it was found that the introduction of a long alkyl chain, such as hexyl, octyl, or dodecyl (or higher alkyl) group on the APP could increase the solubility of APP and QPP. Therefore, an extra alkylation reaction with a long chain alkyl halide was carried out after alkylation of CPP with PEI. Both reactions were conducted in one pot, and quaternization with more reactive alkylating agents, such as methyl iodide or benzyl bromide was followed.

The present disclosure may be understood more readily by reference to the following description taken in connection with the accompanying Figures and Examples, all of which form a part of this disclosure. It is to be understood that this disclosure is not limited to the specific products, methods, conditions or parameters described or shown herein, and that the terminology used herein is for the purpose of describing particular embodiments by way of example only and is not intended to be limiting of any claimed invention. Similarly, unless specifically otherwise stated, any description as to a possible mechanism or mode of action or reason for improvement is meant to be illustrative only, and the disclosure herein is not to be constrained by the correctness or incorrectness of any such suggested mechanism or mode of action or reason for improvement. Throughout this text, it is recognized that the descriptions refer to compositions and methods of making and using said compositions. That is, where the disclosure describes or claims a feature or embodiment associated with a composition or a method of making or using a composition, it is appreciated that such a description or claim is intended to extend these features or embodiment to embodiments in each of these contexts (i.e., compositions, methods of making, and methods of using).

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials, and equivalents thereof known to those skilled in the art, and so forth.

When a value is expressed as an approximation by use of the descriptor “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about.” In other cases, the gradations used in a series of values may be used to determine the intended range available to the term “about” for each value. Where present, all ranges are inclusive and combinable. That is, references to values stated in ranges include every value within that range. For example, integer ranges (e.g., “from 1 to 5”) includes all integers, and subranges described by these integers, as separate embodiments; e.g., 1, 2, 3, 4, or 5, and subranges defined by two or more of these integers. Likewise, decimal ranges (e.g., “from 1.0 to 5.0”) includes all decimals, and subranges described by these decimals, as separate embodiments; e.g., 1.1. 1.2. 1.3, 1.4 . . . 4 . . . 7, 4.8, 4.9, an 5.0 and any subrange defined by two or more of these values.

It is to be appreciated that certain features of the disclosure which are, for clarity, described herein in the context of separate embodiments, may also be provided in combination in a single embodiment. That is, unless obviously incompatible or specifically excluded, each individual embodiment is deemed to be combinable with any other embodiment(s) and such a combination is considered to be another embodiment. Conversely, various features of the disclosure that are, for brevity, described in the context of a single embodiment, may also be provided separately or in any sub-combination. Finally, while an embodiment may be described as part of a series of steps or part of a more general structure, each said step may also be considered an independent embodiment in itself, combinable with others.

The transitional terms “comprising,” “consisting essentially of,” and “consisting” are intended to connote their generally in accepted meanings in the patent vernacular; that is, (i) “comprising,” which is synonymous with “including,” “containing,” or “characterized by,” is inclusive or open-ended and does not exclude additional, unrecited elements or method steps; (ii) “consisting of” excludes any element, step, or ingredient not specified in the claim; and (iii) “consisting essentially of” limits the scope of a claim to the specified materials or steps “and those that do not materially affect the basic and novel characteristic(s)” of the claimed invention. Embodiments described in terms of the phrase “comprising” (or its equivalents), also provide, as embodiments, those which are independently described in terms of “consisting of” and “consisting essentially of.” For those embodiments directed to the formation of the inventive coatings, or the coatings themselves, and provided in terms of “consisting essentially of,” the basic and novel characteristic(s) is the provision of antimicrobial character of the resulting coating and the coatings or substrates so coated.

When a list is presented, unless stated otherwise, it is to be understood that each individual element of that list, and every combination of that list, is a separate embodiment. For example, a list of embodiments presented as “A, B, or C” is to be interpreted as including the embodiments, “A,” “B,” “C,” “A or B,” “A or C,” “B or C,” or “A, B, or C.”

Throughout this specification, words are to be afforded their normal meaning, as would be understood by those skilled in the relevant art. However, so as to avoid misunderstanding, the meanings of certain terms will be specifically defined or clarified.

The term “alkyl” as used herein refers to a linear, branched, or cyclic saturated hydrocarbon group typically although not necessarily containing 1 to about 24 carbon atoms, preferably 1 to about 12 carbon atoms. Linear alkyl groups, such as methyl, ethyl, n-propyl, isopropyl, n-butyl, isobutyl, t-butyl, octyl, decyl, dodecyl, and the like tend to be favored, especially as the alkylating agents. Where R—X is described in terms of R being an alkyl group having 6 to 24 carbon atoms, sub-embodiments include those alkyl groups having 6-8, 8-10, 10-12, 12-14, 14-16, 16-18, 18-20, 20-22, 22-24 carbons, or any combination of two or more of these ranges. The alkyl groups are typically present as a linear isomer. Some functionalization (e.g., branching, unsaturation, or other functionalization) of these linear alkyl groups may be tolerated, provided such functionalization is remote from the site of nucleophilic displacement of X and/or does not practically impair this S_{N}² nucleophilic displaceability of X. Generally, although again not necessarily, alkyl groups herein contain 1 to about 12 or 6 to 24 carbon atoms, depending on the desired effect. The term “lower alkyl” intends an alkyl group of 1 to 6 carbon atoms, and the specific term “higher alkyl” intends a group having 7 to 24 (or even more) carbon atoms. The term “substituted alkyl” refers to alkyl groups substituted with one or more substituent groups, and the terms “heteroatom-containing alkyl” and “heteroalkyl” refer to alkyl groups in which at least one carbon atom is replaced with a heteroatom. If not otherwise indicated, the terms “alkyl,” “lower alkyl,” and “higher alkyl” include linear, branched, cyclic, unsubstituted, substituted, and/or heteroatom-containing such alkyl groups, respectively.

The term “alkylene” as used herein refers to a difunctional linear, branched, or cyclic alkyl group, where “alkyl” is as defined above.

The terms “alkenyl,” “alkenylene,” “alkynyl,” “alkoxy,” “aromatic,” “aryl,” “aryloxy,” “alkaryl,” and “acyl” carry their normal meanings as understood by those skilled in the art of organic chemistry. Reference to any one of more of these terms, either by itself or in combination with another, includes those independent embodiments having 2 to 24 carbon atoms, 2 to 12 carbon atoms, 2 to 6 carbon atoms, 6 to 12 carbon atoms, 12 to 18 carbon atoms, 18 to 24 carbon atoms, or any combination of two or more of these ranges.

The terms “halo,” “halide,” and “halogen” are used in the conventional sense to refer to a chloro, bromo, fluoro, or iodo substituent. The terms “pseudo-halo,” “pseudo-halide,” and “pseudo-halogen” refers to those functional groups exhibiting electronegativity character comparable to convention halides; e.g., nitro, cyano, —CF₃, etc.

“Hydrocarbyl” refers to univalent hydrocarbyl radicals containing 1 to about 30 carbon atoms, preferably 1 to about 24 carbon atoms, most preferably 1 to about 12 carbon atoms, including linear, branched, cyclic, saturated, and unsaturated species, such as alkyl groups, alkenyl groups, aryl groups, and the like. The term “lower hydrocarbyl” intends a hydrocarbyl group of 1 to 6 carbon atoms, preferably 1 to 4 carbon atoms, and the term “hydrocarbylene” intends a divalent hydrocarbyl moiety containing 1 to about 30 carbon atoms, preferably 1 to about 24 carbon atoms, most preferably 1 to about 12 carbon atoms, including linear, branched, cyclic, saturated and unsaturated species. The term “lower hydrocarbylene” intends a hydrocarbylene group of 1 to 6 carbon atoms. “Substituted hydrocarbyl” refers to hydrocarbyl substituted with one or more substituent groups, and the terms “heteroatom-containing hydrocarbyl” and “heterohydrocarbyl” refer to hydrocarbyl in which at least one carbon atom is replaced with a heteroatom. Similarly, “substituted hydrocarbylene” refers to hydrocarbylene substituted with one or more substituent groups, and the terms “heteroatom-containing hydrocarbylene”and heterohydrocarbylene” refer to hydrocarbylene in which at least one carbon atom is replaced with a heteroatom. Unless otherwise indicated, the term “hydrocarbyl” and “hydrocarbylene” are to be interpreted as including substituted and/or heteroatom-containing hydrocarbyl and hydrocarbylene moieties, respectively.

The term “heteroatom-containing” as in a “heteroatom-containing hydrocarbyl group” refers to a hydrocarbon molecule or a hydrocarbyl molecular fragment in which one or more carbon atoms is replaced with an atom other than carbon, e.g., nitrogen, oxygen, sulfur, phosphorus or silicon, typically nitrogen, oxygen or sulfur. Similarly, the term “heteroalkyl” refers to an alkyl substituent that is heteroatom-containing, the term “heterocyclic” refers to a cyclic substituent that is heteroatom-containing, the terms “heteroaryl” and heteroaromatic” respectively refer to “aryl” and “aromatic” substituents that are heteroatom-containing, and the like.

By “substituted” as in “substituted hydrocarbyl” or “substituted alkyl,” and the like, as alluded to in some of the aforementioned definitions, is meant that in the hydrocarbyl, alkyl, or other moiety, at least one hydrogen atom bound to a carbon (or other) atom is replaced with one or more non-hydrogen substituents. Examples of such substituents include, without limitation: functional groups referred to herein as “Fn,” such as halo, hydroxyl, sulfhydryl, C₁-C₂₄ alkoxy, C₂-C₂₄ alkenyloxy, C₂-C₂₄ alkynyloxy, C₅-C₂₄ aryloxy, C₆-C₂₄ aralkyloxy, C₆-C₂₄ alkaryloxy, acyl (including C₁-C₂₄ alkylcarbonyl (—CO-alkyl) and C₆-C₂₄ arylcarbonyl (—CO-aryl)), acyloxy (—O-acyl, including C₂-C₂₄ alkylcarbonyloxy (—O—CO-alkyl) and C₆-C₂₄ arylcarbonyloxy (—O—CO-aryl)), C₂-C₂₄ alkoxycarbonyl ((CO)—O-alkyl), C₆-C₂₄ aryloxycarbonyl (—(CO)—O-aryl), halocarbonyl (—CO)—X where X is halo), C₂-C₂₄ alkylcarbonato (—O—(CO)—O— alkyl), C₆-C₂₄ arylcarbonato (—O—(CO)—O-aryl), carboxy (—COOH), carboxylato (—COO—), carbamoyl (—(CO)—NH₂), mono-(C₁-C₂₄ alkyl)-substituted carbamoyl (—(CO)NH(C₁-C₂₄ alkyl)), di-(C₁-C₂₄ alkyl)-substituted carbamoyl (—(CO)—N(C₁-C₂₄ alkyl)₂), mono-(C₁-C₂₄ haloalkyl)-substituted carbamoyl (—(CO)—NH(C₁-C₂₄ alkyl)), di-(C₁-C₂₄ haloalkyl)-substituted carbamoyl (—(CO)—N(C₁-C₂₄ alkyl)₂), mono-(C₅-C₂₄ aryl)-substituted carbamoyl (—(CO)—NH-aryl), di-(C₅-C₂₄ aryl)substituted carbamoyl (—(CO)—N(C₅-C₂₄ aryl)₂), di-N—(C₁-C₂₄ alkyl), N—(C₅-C₂₄ aryl)-substituted carbamoyl, thiocarbamoyl (—(CS)—NH₂), mono-(C₁-C₂₄ alkyl)-substituted thiocarbamoyl (—(CO)—NH(C₁-C₂₄ alkyl)), di-(C₁-C₂₄ alkyl)-substituted thiocarbamoyl (—(CO)—N(C₁-C₂₄ alkyl)₂), mono-(C₅-C₂₄ aryl) substituted thiocarbamoyl (—(CO)—NH-aryl), di-(C₅-C₂₄ aryl)-substituted thiocarbamoyl (—(CO)—N(C₅-C₂₄ aryl)₂), di-N—(C₁-C₂₄ alkyl), N—(C₅-C₂₄ aryl)-substituted thiocarbamoyl, carbamido (—NH—(CO)—NH₂), cyano(-C≡N), cyanato (—O—C═N), thiocyanato (—S—C═N), formyl (—(CO)—H), thioformyl (—(CS)—H), amino (—NH₂), mono-(C₁-C₂₄ alkyl)-substituted amino, di-(C₁-C₂₄ alkyl)-substituted amino, mono-(C₅-C₂₄ aryl) substituted amino, di-(C₅-C₂₄ aryl)-substituted amino, C₁-C₂₄ alkylamido (—NH—(CO)-alkyl), C₆-C₂₄ arylamido (—NH—(CO)-aryl), imino (—CR═NH where R=hydrogen, C₁-C₂₄ alkyl, C₅-C₂₄ aryl, C₆-C₂₄ alkaryl, C₆-C₂₄ aralkyl, etc.), C₂-C₂₀ alkylimino (—CR═N(alkyl), where R=hydrogen, C₁-C₂₄ alkyl, C₅-C₂₄ aryl, C₆-C₂₄ alkaryl, C₆-C₂₄ aralkyl, etc.), arylimino (—CR═N(aryl), where R=hydrogen, C₁-C₂₀ alkyl, C₅-C₂₄ aryl, C₆-C₂₄ alkaryl, C₆-C₂₄ aralkyl, etc.), nitro (—NO₂), nitroso (—NO), sulfo (—SO₂OH), sulfonate(SO₂O—), C₁-C₂₄ alkylsulfanyl (—S-alkyl; also termed “alkylthio”), C₅-C₂₄ arylsulfanyl (—S-aryl; also termed “arylthio”), C₁-C₂₄ alkylsulfinyl (—(SO)-alkyl), C₅-C₂₄ arylsulfinyl (—(SO)-aryl), C₁-C₂₄ alkylsulfonyl (—SO₂-alkyl), C₁-C₂₄ monoalkylaminosulfonyl-SO₂—N(H) alkyl), C₁-C₂₄ dialkylaminosulfonyl-SO₂—N(alkyl)₂, C₅-C₂₄ arylsulfonyl (—SO₂-aryl), boryl (—BH₂), borono (—B(OH)₂), boronato (—B(OR)₂ where R is alkyl or other hydrocarbyl), phosphono (—P(O)(OH)₂), phosphonato (—P(O)(O)₂), phosphinato (P(O)(O—)), phospho (—PO₂), and phosphine (—PH₂); and the hydrocarbyl moieties C₁-C₂₄ alkyl (preferably C₁-C₁₂ alkyl, more preferably C₁-C₆ alkyl), C₂-C₂₄ alkenyl (preferably C₂-C₁₂ alkenyl, more preferably C₂-C₆ alkenyl), C₂-C₂₄ alkynyl (preferably C₂-C₁₂ alkynyl, more preferably C₂-C₆ alkynyl), C₅-C₂₄ aryl (preferably C₅-C₂₄ aryl), C₆-C₂₄ alkaryl (preferably C₆-C₁₆ alkaryl), and C₆-C₂₄ aralkyl (preferably C₆-C₁₆ aralkyl). Within these substituent structures, the “alkyl” “alkylene,” “alkenyl,” “alkenylene,” “alkynyl,” “alkynylene,” “alkoxy,” “aromatic,” “aryl,” “aryloxy,” “alkaryl,” and “aralkyl” moieties may be optionally fluorinated or perfluorinated.

By “functionalized” as in “functionalized hydrocarbyl,” “functionalized alkyl,” and the like, is meant that in the hydrocarbyl, alkyl, or other moiety, at least one hydrogen atom bound to a carbon (or other) atom is replaced with one or more functional groups such as those described herein and above. The term “functional group” is meant to include any functional species that is suitable for the uses described herein. In particular, as used herein, a functional group would necessarily possess the ability to react with or bond to corresponding functional groups on a substrate surface.

“Optional” or “optionally” means that the subsequently described circumstance may or may not occur, so that the description includes instances where the circumstance occurs and instances where it does not. For example, the phrase “optionally substituted” is equivalent to “substituted or unsubstituted” and means that a non-hydrogen substituent may or may not be present on a given atom, and, thus, the description includes structures wherein a non-hydrogen substituent is present and structures wherein a non-hydrogen substituent is not present.

As usd herein, the term “reacting” means mixing or contacting the two or more ingredients under conditions sufficient to effect the described reaction or transformation, preferably in a suitable solvent. In separate embodiment, such reactions are typically conducted as a solution but also as a dispersion.

Some embodiments comprise methods of forming an anti-microbial surface coating on a substrate, the methods comprising:

a) reacting a polymeric pre-amine material comprising a plurality of the functional groups with a polymeric amine-containing reagent so as to convert at least a portion of the functional groups to amine groups to form a composite polyamine polymer;

b) step-wise reacting the composite polyamine polymer with:
(i) a first alkylating agent, R—X, where R is a C₆-18 alkyl group and X is a leaving group susceptible to nucleophilic displacement, and
(ii) a second alkylating agent that is more active than the first alkylating agent,
so as to convert at least a portion of the amine groups of the composite polyamine polymer to quaternary amine groups, the stepwise reaction resulting in the formation of a mixture of quaternized composite polyamine polymer and quaternized polymeric amine-containing reagent.

As described herein, the pre-amine material is a material that comprises functional groups capable of being converted to amine groups. The pre-amine material is typically, although not necessarily, a polymeric material. For example, the pre-amine material may be a chlorinated polymer such as a chlorinated polyalkylene (e.g., chlorinated polypropylene, chlorinated polybutylene, etc.) or a chlorinated vinyl polymer (e.g., chlorinated polystyrene, chlorinated poly(alpha-methylstyrene), chlorinated poly(isobutylene), etc., or a copolymer thereof. Preferably, these functional groups are susceptible to displacement by amines, more preferably by SN₂ nucleophilic but also SN₁ displacement. Functional groups other than chloro groups are also within the scope of the inventions, though chloro is a preferred functional group. Examples include bromo or iodo groups, hydroxyl groups, or functionalized hydroxy groups. The pre-amine material can range in molecular weights from 1,000 D to 1,000,000 D or more, and is preferably soluble in organic solvents such as toluene or the like.

As described herein, the functional groups on the (polymeric) pre-amine material are subsequently converted to amine groups. Conversion is generally accomplished by reacting the functional groups with a reagent effective to displace the functional groups and convert them to amine groups. For example, in some embodiments, the functional groups are halide groups and are reacted with an amine-containing reagent under conditions effective to convert the halide groups to amine groups. The amine-containing reagent may be, in some embodiments, a polymeric material comprising amine groups in the repeat units of the polymer (either in the polymer backbone, or attached as pendant groups, or a mixture of both). For example, the amine-containing reagent may be a polymer comprising a mixture of primary amines, secondary amines, and tertiary amines. In some embodiments, the polymeric amine-containing reagent is or comprise a poly(ethyleneimine). The poly(ethyleneimine) may be linear or branched, and may contain primary, secondary, and/or tertiary amine groups. One preferred such material is branched poly(ethyleneimine) (PEI). Another material suitable for the disclosed coatings is linear PEI, which comprises secondary amines. Generally herein, reference to “PEI” is meant to include both linear and branched varieties. PEI may be prepared specifically for the uses described herein, or may be purchased commercially. PEI is generally prepared from ethyleneimine, and may be described as having ethylene amine repeat units. PEI suitable for the disclosed coatings may be linear or branched PEI. Other suitable amine-containing reagents include secondary amines such as dihexyl amine and the like. Other suitable amine-containing reagents include tertiary amines such as poly(vinyl pyridine) and the like. Polymeric and oligomeric amine-containing reagents will typically, although not necessarily, have a molecular weight in the range of about 350 D to about 1,000,000 D, or above about 400 D. Once the pre-amine layer is converted (i.e., amine groups are formed), the coating material is referred to herein as an “amine-containing coating material” (or “amine-containing material” or “composite polyamine polymer” to refer to the combination of the (polymeric) pre-amine material and the amine-containing reagent. The amine-containing coating material/composite polyamine polymer may be a crosslinked material, or may be a non-crosslinked material having a molecular weight in the range of about 1,500 D to about 2,000,000 D or greater.

The composite polyamine polymer may contain primary, secondary, and tertiary amine groups, some of this are formed by the displacement of the functional groups of the polymeric pre-amine material by the amine groups of the polymeric amine-containing reagent. The step-wise alkylation by the first and second alkylating agents together serve to increase the alkyl substitution on the amine groups, and especially to increase the concentration of the quaternary amine functionality on the composite polyamine polymer. These first and second alkylating are preferably of the form R—X, where R is alkyl, and preferably a linear alkyl, at least proximate to X, and where X is a leaving group susceptible to S_{N}2 nucleophilic displacement. Alkyl halides may be suitably used (i.e., Br, Cl, or I), though X can also be other groups displaceable in S_{N}2 displacement; e.g., mesylate, tosylate, triflate, etc.

The first and second alkylation steps may be done sequentially, with or without isolating the intermediate products resulting from the first alkylation step, for example by filtration, centrifuging, or decanting the reaction solvent. It is generally more convenient, though, to use apply the sequential reagents by a so-called one-pot method.

The first alkylating agent should have at least 6 carbons in the alkyl chains, preferably longer, to about 16 or 24 carbons. These chain lengths are markedly longer than suggested in previous disclosures, and are helpful in maintaining the hydrophobicity of the composite polyamine polymer and providing hydrophobic pendants from the cross-linked polymers to improve the solubility of the latter in non-polar solvents. This first alkylating reagent may be applied in the presence of a non-nucleophilic base (e.g., an alkali metal carbonate, an alkaline earth metal carbonate, or a tertiary amine base such as triethyl amine or Hunig's base), so as to promote the formation of ternary amines in the composite polyamine polymer.

In embodiments where the amine-containing reagent is a tertiary amine (such as poly(vinyl pyridine)), in some embodiments the reaction product of the amine-containing reagent and the pre-amine material comprises quaternary amine groups. In such embodiments, it is not necessary to react the coating further to form quaternary amine groups (although further conversion to increase the yield of quaternary amine groups may be carried out if desired).

The term, “more active,” as in “second alkylating agent that is more active than the first alkylating agent,” is intended to reflect that the second alkylating agent is more electrophilic, more susceptible to nucleophilic displacement, or allows for quarternization of even more hindered tertiary amines. Shorter alkyl chains or the presence of more efficient leaving groups on the second alkylating group or both, relative to those on the first alkylating groups are exemplary strategies for heightening this activity. In is not uncommon that the second alkylating agent is a lower alkyl cogener of the first alkylating agent, and is preferably a lower alkyl halide. The less steric hindrance associated with lower alkyl or benzyl halides and the better leaving group activities of iodide and bromide make methyl iodide, methyl bromide, benzyl iodide, or benzyl bromide attractive second alkylating agents.

In some cases, steps (a) and (b) above results in the formation of a mixture of quaternized composite polyamine polymer and quaternized polymeric amine-containing reagent (e,g, in some cases, quaternized alkylpoly(ethyleneimine)). In some cases, the ratio of the quaternized composite polyamine polymer and quaternized polymeric amine-containing reagent can be 1:1, 1:2, 1:3, 1:4, 1:5 or less, depending on the nature of the two reagents. The quaternized composite polyamine polymer may be used as prepared or it may be purified to remove residual impurities before applying it to a substrate surface (e.g., to improve leach resistance of the final coatings). Such impurities may include, for example, residual or incompletely reacted starting materials or salt by-products. In those circumstances where the polymeric pre-amine material and the polymeric amine-containing reagent do not effectively couple, the resulting alkylating steps can also result in the formation of quaternized polymeric amine-containing reagent, the relative amounts reflective of the original pre-quaternized compositions. It is not uncommon for the coupling of the pre-amine material and the amine-containing reagent to react in relatively low yields, depending on the physical nature of each material and the steric effects reflected in each (e.g., where both the pre-amine material and the amaine-containing reagents are polymeric). In some cases, it is desireable to remove this quaternized polymeric amine-containing reagent from the quaternized composite polyamine polymer. This can be accomplished by isolating the solid reaction product after the step-wise alkylation and washing solid mixtures of these two materials with water and/or lower alcohols (e.g., methanol, ethanol, n-propanol, or isopropanol), the former quaternized reagent being soluble in such solvents wherein the latter quaternized composite is not. Depending on the rigor of this purification process, the resulting composite mixture may contain less than 50 wt %, less than 40 wt %, less than 30 wt %, less than 20 wt %, or less than 10 wt % of the quaternized amine-containing reagent, relative to the entire weight of the composition. In preferred embodiments, the resulting quaternized composite polyamine polymer is substantially free of the quaternized polymeric amine-containing reagent. As used herein, the term “substantially free” refers to a composition in which the levels of the quaternized polymeric amine-containing reagent (such as quarternized free poly(ethyleneimine)) is less than 10 mole %, 5 mol %, less than 1 mol % relative to the total quaternized composite polyamine polymer.

The present methods are flexible in that either the mixture of the quaternized composite polyamine polymer and the quaternized polymeric amine-containing reagent or the purified quaternized composite polyamine polymer may subsequently applied to a substrate. In either case, either the mixture or the purified quaternized composite polyamine polymer may be dissolved in a suitable organic solvent and the resulting solution applied to the substrate. This may include dissolving at least the quaternized composite polyamine polymer in an organic solvent to form a solution of the quaternized composite polyamine polymer. The resulting solution of the quaternized composite polyamine polymer may be applied to the substrate by conventions coating methods. Once applied, the organic solvent is removed and the substrate is left coated with the quaternized composite polyamine polymer.

Such organic solvents may comprises one or more of an aromatic hydrocarbon, a halogenated solvent, a cyclic ether, or a C₁₋₆ alcohol. In some embodiments, these include one or more of toluene, dichloromethane, methanol, ethanol, tetrahydrofuran, 2-methyl tetrahydrofuran, or isopropanol. Mixtures of these solvents tend to be preferred.

Whether purified or not, the quaternized composite polyamine polymer may be dissolved in a suitable organic solvent to form a coating solution. This coating solution may be applied to a substrate by any conventional coating means, for example brush coating, dip coating, spin coating, or spray coating. After removing the organic solvent, the substrate is left coated with the quaternized composite polyamine polymer. This coating enures homogeneous antimicrobial activity to the substrate.

While described thusfar in terms of methods, it should be appreciated that any compositions, derived from any one or more of the disclosed methods or method steps, is within the scope of the present disclosure, including any solid or solution mixture thereof. For example, the product of each step of the step-wise alkylations or the crude or purified composite polyamine polymer, each either as an isolated solid or dissolved in solution, are considered separate embodiments.

It should also be appreciated that the coating layer prepared by the disclosed methods that exhibits anti-microbial activity is a separate embodiment of this disclosure. In still further embodiments, the anti-microbial activity of these coatings is at least as efficaceous as presented in the Examples described herein.

Nature of the Quaternary Amine Coatings

In some embodiments, the quaternary amines present in the disclosed coatings comprise the structure of formula (I)

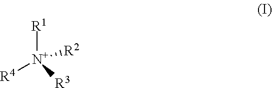

wherein R¹, R², R³, and R⁴ are independently selected from hydrocarbyl, heteroatom-containing hydrocarbyl, and substituted heteroatom-containing hydrocarbyl. In some embodiments, R¹, R², R³, and R⁴ are independently selected from alkyl, alkenyl, alkynyl, aryl, aralkyl, and alkaryl, any of which may contain one or more (e.g., 2, 3, 4, etc.) substituents and one or more (e.g., 2, 3, 4, etc.) heteroatoms. In some embodiments, one of R¹, R², R³, and R⁴ is a sidechain (comprising, e.g., a linking group selected from alkylene and arylene) that is connected to the backbone of a larger polymer. In some embodiments, the nitrogen atom is part of the backbone of a polymer, such two (in the case of linear polymers) or three (in the case of branched polymers) of R¹, R², R³, and R⁴ represent backbone portions of the polymer. In some embodiments one of more of R¹, R², R³, and R⁴ is selected from C₁-C₁₂ alkyl, such as methyl, ethyl, propyl, and the like. In some embodiments three of R¹, R², R³, and R⁴ comprise polymer backbone groups such that the nitrogen atom is a branch point in the polymer material that forms the coating. In such embodiments, the polymer may be branched, highly branched, or cross-linked.

In some embodiments, the disclosed coatings are polymers comprising quaternary amine groups having structures selected from (Ia)-(Ic):

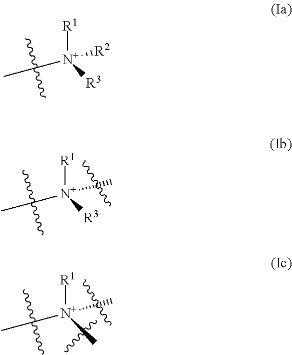

wherein R¹, R², and R³ are as described above and the wavy lines represent polymeric moieties. Any combination of structures (a)-(c) may be present in the disclosed polymeric materials. For example, in some embodiments, the materials contain only structure (a), whereas in some embodiments the materials contain a combination of structures (a), (b), and (c).

In some embodiments, the disclosed coatings prior to quaternization comprise polymers having the structure of formula (II)

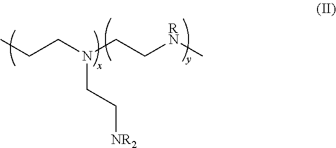

wherein x and y are non-negative integers (including zero). Subsequent to quaternization of such materials, all or a portion of the nitrogen atoms in the polymer structure are converted to cationic moieties such as in the structure of formula (IIa)

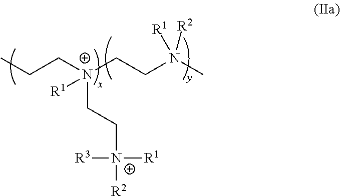

Accordingly, in some embodiments, the disclosed coatings comprise branched or cross-linked polymers that comprise quaternary amine groups as part of the backbone polymer structure (i.e., “non-terminal” quaternary amines groups). In some embodiments, the disclosed coatings comprise branched or cross-linked polymers that comprise quaternary amine groups as sidegroups (i.e., “terminal” quaternary amine groups) to the polymer structure. In some embodiments, the disclosed coatings comprise branched or cross-linked polymers that comprise both terminal and non-terminal quaternary amine groups.

In some embodiments, the disclosed coatings are prepared from non-peptidic polymeric materials. That is, the materials that form the coatings are synthetic organic polymers and are neither synthetic nor natural polypeptides. That is, in some embodiments, the disclosed coatings are formed from polymers that are other than polyamino acids.

In preferred embodiments, the disclosed coatings have anti-bacterial properties that are inherent in the coatings—i.e., the coatings do not contain antibacterial compounds “dissolved” therein and prone to leaching out of the coatings. For example, the disclosed antibacterial coatings do not contain silver ions dissolved therein. Furthermore, as described supra, the disclosed coatings are not covalently bonded to the substrate surface.

Coatings and Coated Substrates

The disclosure also allows for a range of substrates coated on at least one surface with a material that comprises quaternary amine groups. The quaternary aminies present in the surface coatings impart anti-bacterial properties to the substrate. The presence of the quaternary ammonium groups may be detected and measured spectroscopically (as described herein) or may be inferred by the anti-microbial activity of the coatings. In some embodiments, the surface coatings are not covalently bonded to the substrate surface, but nevertheless form stable coatings that exhibits minimal or no leaching, dissolution, and/or degradation when exposed to an aqueous environment. Accordingly, the coatings are generally safe for use in biological applications such as coatings on contact lens storage cases. The coatings are also stable in dry environments, and may be used to prevent bacterial growth in a variety of applications as described herein. In sonic embodiments, the surface coatings are conformal such that they coat the entire substrate surface (i.e., there are no gaps of exposed substrate that could support bacterial growth). In some embodiments, the coatings uniformly cover the substrate surface (e.g., the coating thickness may vary by less than 25%, or by less than 15%, or by less than 10% from the average over the area of the surface covered). Generally, the coatings bond to the substrate surface via one or more of Vander Waals forces, ionic bonding, and hydrogen bonding.

In preferred embodiments, the disclosed coatings are highly water insoluble. Accordingly, in preferred embodiments, the disclosed coatings allow no or minimal “leaching” into aqueous environments—i.e., upon exposure to an aqueous environment, substantially none of the material present in the disclosed coatings are dissolved. For example, in some embodiments, less than 25%, or less than 20%, or less than 15%, or less than 10%, or less than 5%, or less than 3%, or less than 1%, or less than 0.1% by weight of the disclosed coatings are leached into an aqueous environment (at room temperature) over a period of 1 hour, or 10 hours, or 15 hours, or 24 hours, or 3 days, or 1 week, or 1 month, or 1 year. This degree of leach resistance can conceiably correlate with the presence of residual quaternized amine-containing regent. But even if any residual quaternized amine-containing regent is still present as a leachable material, the coating may still provide uniform antibacterial effect if the residual quaternized amine-containing regent is uniformly distributed in the coating.

In some embodiments, the disclosed coatings are stable to common processing conditions for the devices and substrates described herein. For example, the coatings are stable toward sterilization using heat, chemical sterilizers (e.g., ethylene oxide), and/or steam.

In some embodiments, the disclosed coatings cover all external surfaces of the substrate. In some embodiments, the coatings cover only a portion of the external surfaces of the substrate, such as one surface, or a plurality of surfaces. The coatings may be any suitable thickness. A suitable thickness is typically one that allows the coating to fully cover the underlying substrate surface, such that few or no pinholes or bare spots remain. For example, suitable thicknesses include those with the range of about 10 nm to about 0.1 nm, or about 100 nm to about 0.1 MM. or about 1000 nm to about 0.1 mm. For example, suitable thicknesses may be less than about 0.1 mm, or less than about 10 microns, or less than about 1 micron, or greater than about 100 nm, or greater than about 1000 nm, or greater than about 10 microns.

In some embodiments, a disclosed coating is prepared from the same type or class of material as the substrate. For example, in some embodiments, the substrate is polypropylene, and the quaternized composite polyamine polymer is also derived from a functionalized polypropylene (modified as described herein to contain quaternary amine groups), in some embodiments, the pre-amine material and the substrate comprise the same type of material, but the amine-containing reagent comprises a different material. For example, both the substrate and the pre-amine material comprise polypropylene (in the case of the pre-amine material, a modified polypropylene such as chlorinated polypropylene), and the amine-containing reagent is polyethyleneimine. In some embodiments, the pre-amine material and the amine-containing reagent are both polymers, but comprise different repeat units. In other embodiments, the pre-amine material and the amine-containing reagent are both polymers, and comprise the same repeat units.

In some embodiments, the quaternized composite polyamine polymer is non-covalently bonded to the substrate, for example by hydrogen bonding, Van der Waals forces, ionic bonding or a combination thereof. It is sometimes preferred that the structure of the backbone of the substrate is compatible with that of the quaternary composite polyamine.

Substrate Materials

The present disclosure provides coatings disposed upon substrates. The substrate supports the disclosed coatings, and also provides structural functionality to carry out the applications described herein (e.g., storage, structural support, etc.). The substrate may have a variety of shapes and properties, and may be made from a variety of materials as described in more detail below.

In some embodiments, the substrate is designed to perform a biological function, such as a providing structural support, or functioning as a replacement component for a biological organism, or assisting a medical procedure. In some embodiments, the substrate is designed to provide storage, such as storage of biological samples, objects having a biological function, tools and other materials used in medical procedures, and the like. Examples of suitable substrates include stents, catheters, and the like.

The shape and topography of the substrate and substrate surface to be coated will be selected according to the intended use. For example, storage containers may include lids that are also intended to be coated with the disclosed coatings.

In some embodiments, the substrate comprises an organic polymeric material. For example, some preferred polymer materials for the substrate include polyalkylenes such as polyethylene, polypropylene, polybutylene, and poly(isobutylene), vinyl polymers such as polystyrene, poly(vinylchloride), poly(methacrylate), poly(methylmethacrylate), polyesters such as poly(ethylene terephthalate), other addition polymers such as polyurethane, polycarbonate, polyamide, ABS, polyisoprene rubber, and copolymers of the above (e.g., copolymers having alkylene and/or vinyl repeat units). Siloxane (i.e., silicone) polymers are also suitable substrate materials, including polydimethylsiloxane polymers and the like. Natural latex rubber polymers are also a preferred substrate material. Derivatives of any of the foregoing polymers and copolymers are also within the scope of the invention.

In some embodiments, the substrate comprises an inorganic polymer or glass, such as a silicate glass, aluminosilicate glass, or borosilicate glass.

In some embodiments, the substrate comprises a natural or synthetic fabric or a cellulosic material (e.g., wood or wood by-product). In fact, the nature of the substrate is not practically limited, though better non-covalent attachment is realized if the chemical structure of the quaternized composite polyamine polymer share an analogous backbone structure.

In other embodiments, the substrate comprises a metal or alloy. For example, stainless steel commonly used in surgical instruments is a suitable substrate for the disclosed coatings. Other metals such as those commonly used in surgical implants, storage containers, watercrafts hulls, etc. are also suitable as substrates. Examples of specific metals include steels (e.g., carbon steel, alloy steel such as stainless steel, etc.) and alloys containing nickel, titanium, copper, tin, chromium, molybdenum, etc.

Uses

The coating materials of the present disclosure are suitable for a variety of uses and applications. In some embodiments, the disclosed coating materials vention are suitable for medical uses such as for coating biomedical devices, medical tools, objects intended to contact a biological organism, and any storage units for storage of such items. For example, the disclosed coating materials are suitable for coating the surfaces of storage containers intenped for storage of items such as biologics (e.g., biomedical devices, biologic medications, etc.), corrective eyewear, dental appliances and other dental devices, catheters, stents, pharmaceuticals, medical instruments, and the like. The disclosed coating materials are also suitable in non-medical applications, such as in the food service industry. For example, the disclosed coating materials are suitable for coating the surfaces of storage containers intended for storage of items such as cooking utensils, cleaning solutions, rinse solutions, certain food items, and the like. The disclosed coatings may also be used in the farming and livestock industry, such as to prevent the spread of bacteria in food-processing facilities.

In some embodiments, the disclosed coatings are suitable for preventing bacterial infections and the spread of bacteria in a hospital environment. In such embodiments, the coatings may be applied to various surfaces that commonly support bacterial growth (and therefore exacerbate the spread of bacterial infections), and/or may be applied to medical instruments and other items used in medicine (e.g., catheters, stents, surgical tools, stethoscopes, orthopedic screws, etc.).

In some embodiment, the disclosed coatings are suitable for preparing polypropylene contact lens storage cases that will prevent bacterial contamination of lenses. In such embodiment, the quaternized amine coating forms an anti-bacterial coating on at least the inside surface of the storage case. Even with repeated use and minimal cleaning (i.e., simple rinsing with water), the antibacterial properties of the quaternized amine coatings prevent bacterial growth on the surface(s) of the case. Prevention of such growth therefore also prevents bacterial growth when contact lens storage solution and contact lenses are added to the case, which prevents the transfer of bacteria into the eyes of the contact lens wearer. Preferred contact lens cases are prepared from polypropylene. Where polypropylene is used as the substrate, a preferred support layer comprises polypropylene (and may further comprise, for example, polyethylene units, additives, etc.).

Contact lens cases coated with the disclosed quaternized amine coatings may be prepared as single-use storage containers or as multiple-use containers. The containers may be intended for short term storage (e.g., minutes or hours), medium term storage (e.g., overnight or several days) and/or for long terms storage (e.g., weeks or months or longer).

In some embodiments, the disclosed coatings are used to prepare anti-bacterial coatings on contact lenses. Daily-wear, single use, and extended wear contacts (including both hard and soft varieties) may be coated with the disclosed coatings. Accordingly, in one embodiment, the disclosure includes a contact lens comprising an anti-bacterial coating wherein the antibacterial coating comprises quaternary amines as disclosed herein.

In another embodiment, the disclosed coating may be used to coat at least one surface of a catheter and/or of a case for storing a catheter. Suitable catheters include urinary catheters, venous catheters, umbilical lines, balloon catheters, and the like.

In another embodiment, the disclosed coatings may be used to coat metals used, for example, in surgical instruments. Surgical tools having a coating according to the present disclosure are less susceptible to supporting and spreading bacterial infections during surgical procedures.

In some embodiments, the disclosed coatings ion are applied to objects as part of the manufacturing process, That is, the coatings are applied prior to leaving the manufacturing facility. In some embodiments, the coatings are applied (or re-applied) to a re-usable object in a re-sterilization process, which in some embodiments is carried out prior to final sterilization (e.g., using steam or ethylene oxide).

In some embodiments, the disclosed coatings have anti-bacterial properties that suppress (either completely or partially) the growth of a variety of types of bacterial. In some embodiments, the disclosed coatings are biocidal towards a variety of types of bacterial. In some embodiments, the coatings kill and/or suppress the growth of both Gram-positive and Gram-negative bacteria, as well as drug-resistant bacteria. The coatings kill and/or suppress the growth of bacteria selected from the genera. Escherichia, Enterobacter, Salmonella, Staphylococcus, Shigella, Listeria, Aerobacter, Helicobacter, Klebsiella, Proteus, Pseudomonas, Streptococcus, Chlamydia, Mycoplasma, Pneumococcus, Neisseria, Clostridium, Bacillus, Corynebacterium, Mycobacterium, Campylobacter, Vibrio, Serratia, Providencia, Chromobacterium, Brucella, Yersinia, Haemophilus, Bordetella, Burk. holderia, Acinetobacter, Enterococcus, and Francisella. For example, in some embodiments, the coatings kill and/or suppress the growth of Pseudomonas aeruginosa, Pseudomonas aeruginosa, coagulase-negative Staphylococci, Enterococcus faecalis, Streptococcus viridans, Escherichia coli, Proteus mirabilis, and/or Staphylococcus aureus (including methicillin-resistant Staphylococcus aureus (MRSA) and methicillin-susceptible Staphylococcus aureus (CISSA)). In some embodiments, the coatings of the present disclosure are effective against bacteria that have infected and bred within protozoa, such as MRSA (methicillin-resistant Staphylococcus aureus) bred within acanthameoha. In some embodiments, the disclosed coatings have anti-fungal properties. In some embodiments, the disclosed coatings have anti-protozoan properties (e.g. against acanthameoba).

In some embodiments, the disclosed coatings are disposed on a substrate and are effective to inhibit the growth of bacteria on the substrate. For example, upon exposure to an aqueous medium comprising bacteria, a substrate comprising a disclosed coating will exhibit 70% less, or 80% less, or 90% less, or 95% less, or 98% less, or 99% less, or 99.9% less, or 99.99% less bacterial growth on the substrate over a predetermined period of time (e.g., 1 hour, 10 hours, 24 hours, 48 hours, 72 hours, etc.) compared with a similar substrate lacking such a coating.

In some embodiments, the disclosed coatings are effective to reduce a population of bacteria in a solution contacting the coatings. For example, upon exposure to a solution containing a population of bacteria, a substrate comprising a disclosed coating will reduce the bacterial population in the solution by at least 50%, or at least 60%, or at least 70%, or at least 80%, or at least 90%, or at least 95%, or at least 98%, or at least 99%, or at least 99.9%, up to practically 100% over a predetermined period of time (e.g., 1 hour, 10 hours, 24 hours, 48 hours 72 hours, etc.) compared with a similar substrate lacking such a coating.

The following listing of embodiments in intended to complement, rather than displace or supersede, the previous descriptions.

### Embodiment 1

A method for forming an anti-microbial surface coating on a substrate, the method comprising:

a) reacting a polymeric pre-amine material comprising a plurality of the functional groups, with a polymeric amine-containing reagent, so as to convert at least a portion of the functional groups to amine groups to form a composite polyamine polymer;

b) step-wise reacting the composite polyamine polymer with:
(i) a first alkylating agent, R—X, where R is an alkyl group having at least 6 carbons and X is a leaving group, and
(ii) a second alkylating agent that is more reactive than the first alkylating agent,
so as to convert at least a portion of the amine groups of the composite polyamine polymer to quaternary amine groups, the stepwise reaction resulting in the formation of a quaternized composite polyamine polymer.

In some cases, steps (a) and (b) results in the formation of a mixture of quaternized composite polyamine polymer and quaternized polymeric amine-containing reagent (e, g, in some cases, quaternized alkylpoly(ethyleneimine)). In those cases, further Aspects of this Embodiment comprise

c) optionally removing the quaternized polymeric amine-containing reagent from the quaternized composite polyamine polymer.

Either the mixture of the quaternized composite polyamine polymer and the quaternized polymeric amine-containing reagent or the purified quaternized composite polyamine polymer may subsequently applied to a substrate, in which case either the mixture or the purified quaternized composite polyamine polymer may be dissolved in a suitable organic solvent and the resulting solution applied to the substrate. Therefore, in further Aspects of this Embodiment, steps include:

d) dissolving at least the quaternized composite polyamine polymer in an organic solvent to form a solution of the quaternized composite polyamine polymer; and

e) applying the solution of the quaternized composite polyamine polymer to the substrate and removing the organic solvent, such that the substrate is coated with the quaternized composite polyamine polymer.

### Embodiment 2

The Embodiment of Embodiment 1, wherein the polymeric pre-amine material is a polyhalogenated polymer. That is, the plurality of functional groups associated with the polymeric pre-amine material comprise one or more types of halogen atoms. The halogen in such a polymer may be one or more of chloro, bromo, or iodo. Chloro is one such preferred functional group.

### Embodiment 3

The method of Embodiment 1 or 2, wherein the polymeric pre-amine material is a chlorinated polypropylene. Other polymer backbones can be used in this capacity, and in other independent Aspects of this Embodiment, the polymeric pre-amine material is a polybromopropylene, polychloroethylene, polybromoethylene, polychlorobutylene, polybromobutylene, or copolymers of two or more of such polymers.

### Embodiment 4

The method of any one of Embodiments 1 to 3, wherein the polymeric amine-containing reagent is or comprises a poly(ethyleneimine). In certain Aspects of this Embodiment, the poly(ethyleneimine) is a linear poly(ethyleneimine) comprising secondary amines. In other independent Aspects of this Embodiment, the poly(ethyleneimine) is a branched poly(ethyleneimine) comprising primary, secondary, and tertiary amines. In still other Aspects of this Embodiment, the poly(ethyleneimine) has a molecular weight in the range of 350 Daltons to 1,000,000 Daltons.

### Embodiment 5

The method of any one of Embodiments 1 to 4, wherein the reaction between the polymeric pre-amine material and the polymeric amine-containing reagent results in a coupling of the materials by nucleophilic displacement of at least a portion of the functional groups of the polymeric pre-amine material by at least a portion of the amines associated with the polymeric amine-containing reagent.

### Embodiment 6

The method of any one of Embodiments 1 to 5, wherein the alkyl group of the first alkylating agent contains 6 to 24 carbon atoms, preferably in a linear arrangement or in a linear arrangement for the 6 carbon atoms closes the X leaving group. Independent Aspects of this Embodiment include those where the first alkylating agent contains 6, 7, 8, 9, 10, 11, 12, 13, 14, 15, 16, 17, 18, 19, 20, 21, 22, 23, 24, or 25 carbon atoms.

### Embodiment 7

The method of any one of Embodiments 1 to 6, wherein the X leaving group of the first alkylating agent, R—X is a halide such as Cl⁻, Br⁻, and I⁻, or a sulfonate esters such as a mesylate, tosylate, or triflate. C₆₋₂₄ alkyl halides are attractive first alkylating agents.

### Embodiment 8

The method of any one of Embodiments 1 to 7, wherein the reaction of the composite pre-amine polymer with the first alkylating agent is done in the presence of non-nucleophilic base. In some preferred Aspects, this non-nucleophilic base is a weak base, for example an alkali metal carbonate, an alkaline earth metal carbonate, or a tertiary amine base such as triethyl amine or Hunig's base

### Embodiment 9

The method of any one of Embodiments 1 to 8, wherein the product of the reaction between the composite pre-amine polymer and the first alkylating agent is isolated before the further reaction with the second alkylating agent.

### Embodiment 10

The method of any one of Embodiments 1 to 9, wherein the second alkylating agent is a lower alkyl cogener of the first alkylating agent, and is preferably a lower alkyl halide. The less steric hindrance associated with lower alkyl or benzyl halides and the better leaving group activities of iodide and bromide make methyl iodide, methyl bromide, benzyl iodide, or benzyl bromide attractive second alkylating agents.

### Embodiment 11

The method of any one of Embodiments 1 to 10, wherein a solid resulting obtained after the first and second alkylations is isolated as a solid. This product can be a mixture of quaternized composite polyamine polymer and quaternized alkylpoly(ethyleneimine).

### Embodiment 12

The method of any one of Embodiments 1 to 11, wherein the quaternized alkylpoly(ethyleneimine) is removed from the mixture of quaternized composite polyamine polymer and quaternized polymeric amine-containing reagent prior to dissolving the quaternized composite polyamine polymer in the organic solvent. Again, in certain Aspects of this Embodiment, the quaternized polymeric amine-containing reagent is or comprises a quaternized alkylpoly(ethyleneimine).

### Embodiment 13

The method of any one of Embodiments 1 to 12, wherein the quaternized polymeric amine-containing reagent is removed from the quaternized composite polyamine polymer by washing a solid mixture of the quaternized polymeric amine-containing reagent and the quaternized composite polyamine polymer with solvent comprising water, a C₁-3 alcohol, or a solvent system comprising these solvents. Again, in certain Aspects of this Embodiment, the quaternized polymeric amine-containing reagent is or comprises a quaternized alkylpoly(ethyleneimine).

### Embodiment 14

The method of any one of Embodiments 1 to 13, wherein the resulting quaternized composite polyamine polymer is substantially free of the quaternized polymeric amine-containing reagent. Again, in certain Aspects of this Embodiment, the quaternized polymeric amine-containing reagent is or comprises a quaternized alkylpoly(ethyleneimine).

### Embodiment 15

The method of any one of Embodiments 1 to 14, wherein the organic solvent used to solubilize the quaternized composite polyamine polymer of step (d) comprises one or more of an aromatic hydrocarbon, a halogenated solvent, or a C₁-6 alcohol.

### Embodiment 16

The method of Embodiment 15, wherein the organic solvent comprises one or more of toluene, dichloromethane, methanol, ethanol, or isopropanol.

### Embodiment 17

The method of any one of Embodiments 1 to 16, wherein the substrate is an organic polymer, an inorganic polymer or glass, or a metal. In certain Aspects of this Embodiment, the substrate is or comprises polyethylene, polypropylene, polybutylene, polyester, polyethylene terephthalate, polyurethane, polycarbonate, polyamide, polystyrene, polyvinyl chloride, ABS, polyisoprene rubber, or a copolymer or mixture thereof. In other Aspects, the substrate may be a natural or synthetic fabric or a cellulosic material (e.g., wood or wood by-product). In fact, the nature of the substrate is not practically limited, though better non-covalent attachment is realized if the chemical structure of the quaternized composite polyamine polymer share an analogous backbone structure.

### Embodiment 18

The method of any one of Embodiments 1 to 17, wherein the solution comprising the quaternized composite polyamine polymer is applied to the substrate by brush coating, dip coating, spin coating, or spray coating.

### Embodiment 19

The method of any one of Embodiments 1 to 18, wherein the described polymers, including the composite polyamine polymer, or quaternized derivatives thereof, are not polyamino acids.

### Embodiment 20

A composition derived from any one of the Embodiments 1 to 19.

### Embodiment 21

A composition comprising a quaternized composite polyamine polymer prepared by:

a) reacting a polymeric pre-amine material comprising a plurality of the functional groups, with a polymeric amine-containing reagent, comprising poly(ethyleneimine), so as to convert at least a portion of the functional groups to amine groups to form a composite polyamine polymer;

b) step-wise reacting the composite polyamine polymer with
(i) a first alkyl halide, R—X, where R is a C₆₋₁₈ alkyl group and X is Br or I, and
(ii) a second alkyl halide that is more electrophilic than the first alkyl halide,
so as to convert at least a portion of the amine groups of the composite polyamine polymer to quaternary amine groups, the stepwise reaction resulting in the formation of a mixture of quaternized composite polyamine polymer and quaternized alkylpoly(ethyleneimine);

c) optionally removing the quaternized alkylpoly(ethyleneimine) from the quaternized composite polyamine polymer. In independent aspects of this Embodiment, the coating exhibits anti-microbial activity. In still further Aspects of this Embodiment, the anti-microbial activity is at least as efficaceous as presented in the Examples described herein.

### Embodiment 22

A solution comprising the quaternized composite polyamine polymer of Embodiment 21 dissolved in an organic solvent. Such organic solvents are described elsewhere herein.

### Embodiment 23

A coating layer prepared by the method of any one of Embodiments 1 to 19 that exhibits anti-microbial activity. In still further Aspects of this Embodiment, the anti-microbial activity is at least as efficaceous as presented in the Examples described herein.

### Embodiment 23

A coated substrate prepared by the method of any one of Embodiments 1 to 19 that exhibits anti-microbial activity. In still further Aspects of this Embodiments, the anti-microbial activity is at least as efficaceous as presented in the Examples described herein.

### Embodiment 24

A coating layer comprising a quaternized composite polyamine polymer, the composite polyamine polymer prepared by the reaction between a polymeric pre-amine material comprising a plurality of the functional groups, with a polymeric amine-containing reagent optionally comprising poly(ethyleneimine), such that at least a portion of the functional groups of the polymeric pre-amine material have been converted to amine groups;

wherein at least a portion of the converted amine groups are quaternized by a first alkyl halide, R—X, where R is a C₆₋₁₈ alkyl group and X is Br or I;

the coating layer exhibiting anti-microbial activity.

### Embodiment 25

The coating layer of Embodiment 24, wherein the quaternized composite polyamine polymer is substantially free of a corresponding quaternized free poly(ethyleneimine). The term “substantially free” refers to a composition in which the levels of the quaternized free poly(ethyleneimine) is less than 5 mol %, less than 1 mol % relative to the total quaternized composite polyamine polymer.

### Embodiment 26

A coated substrate comprising a coating layer of Embodiment 24 or 25 that exhibits anti-microbial activity.

### Embodiment 27

The coated substrate of Embodiment 23 or 26, wherein the substrate is an organic polymer. In some Aspects of this Embodiment, the organic polymer comprises polypropylene, chlorinated polypropylene, polyethylene, polyurethane, polycarbonate, polyamide, polystyrene, polyester terephthalate, polyvinyl chloride, ABS, polyester, polyisoprene rubber, or a copolymer or mixture thereof.

### Embodiment 28

The coated substrate of any one of Embodiments 23, 26, or 27, wherein the quaternized composite polyamine polymer is non-covalently bonded to the substrate. It is sometimes preferred that the structure of the backbone of the substrate is compatible with that of the quaternary composite polyamine.

### Embodiment 29

The coated substrate of Embodiment 28, wherein the quaternized composite polyamine, wherein the coating is bonded to the substrate via hydrogen bonding, Van der Waals forces, ionic bonding or a combination thereof.

### Embodiment 30

The method, coating layer, or coated substrate of any one of the preceding Embodiments, wherein the described polymers, including the composite polymer, or quaternized derivatives thereof, are not polyamino acids.

### EXAMPLES

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

The synthetic methods and experimental protocols and experimental results described in U.S. Pat. No. 8,512,722 are incorporated by reference herein in their entireties.

### Example 1. Exemplary Preparation of Quaternized Polypropylene (QPP)

Chlorinated polypropylene (CPP, 1 g; ˜26% chlorine content, MW of about 100,000, purchased from Aldrich) was dissolved in a mixture of toluene and THF (20 mL and 15 mL, respectively) at room temperature. Polyethyleneimine (ex: branched PEI, 2 g, Mw ca. 25,000; 10,000 by GPC, purchased from Aldrich) was separately dissolved in acetone (10 mL). The two solutions were combined and the mixture was stirred for 3 days at 50° C. Without workup, potassium carbonate (7.5 g), alkyl bromide (e.g., bromohexane, bromooctane, bromododecane; 12.8 mL) and t-amyl alcohol (10 mL) were added to the same pot to perform additional alkylation. After stirring overnight at a temperature in a range of from about 80° C. to 90° C., a white silid was removed by centrifugation. The solution was decanted to a 250 mL bottle, to which methyl iodide (5.7 mL) or benzyl bromide (10.8 mL) was added (to quaternize the product). The mixture was stirred at 50° C. overnight (to produce the quaternized polypropylene (QPP)), after which the volatile chemicals were removed under reduced pressure to obtain a dark brown, viscous liquid. Upon addition of n-hexane, a solid precipitated. This solid was washed further with n-hexane and vacuum dried to yield crude QPP (10.5 g). This crude product was washed repeatedly with water and methanol to remove quaternized alkylpolyethylimine (QPEI) impurities and salt by-products. The purified QPP material was obtained as a brown solid after vacuum drying (yield: 2.63 g from 9.89 g crude product).

### Example 1.1. Dip-Coating onto Polypropylene Surface

A polypropylene disk (3.5 cm diameter) was dipped in a vial containing 10 wt % solution of the QPP in a toluene-methylene chloride-methanol (1:1:0.2) solvent system. The disk was air dried, and washed successively with water and methanol for one hour under vigorous stirring. The coated disk was dried under vacuum for future use.

### Example 1.2. Spray-Coating onto Polypropylene Surface—Method 1

A dilute solution (1 wt %) of the QPP in a toluene-methylene chloride-methanol (1:1:0.4) solvent system was spray coated (using air-brush spray gun, H-100D, Paasche, USA) was sprayed onto a surface of a polypropylene disk to provide a coating of ca. 4 mg QPP/cm². The disk was air dried, and washed successively with methanol and de-ionized water for 30 minutes with vigorous stirring. The coated disk was dried under vacuum for future use.

### Example 1.3. Spray-coating onto Polypropylene Surface—Method 2

A dilute solution (1 wt %) of the QPP in a toluene-isopropanol (6:1) solvent system was spray coated (using air-brush spray gun, H-100D, Paasche, USA) was sprayed onto a surface of a polypropylene disk to provide a coating of ca. 4 mg QPP/cm². The disk was air dried, and washed successively with methanol and de-ionized water for 30 minutes with vigorous stirring. The coated disk was dried under vacuum for future use.

### Example 1.4. Adhesion Testing for QPP Coated Polypropylene Surface

Using samples prepared according to Example 1.3, the QPP coated surface was cut in a hatched pattern with a sharp razor blade (distance between the cutting lines ˜1 mm). A piece of self-adhesive 2″ lab paper tape tightly stuck on the surface of cutting lines was quickly removed. Classification of adhesion was determined by counting peeled-off coating surface/shape based on ASTM D3359-97, which identified that adhesion strength of QPP coating on polypropylene was significantly high with the range of from about 4B to about 5B (survived >95% of coated area) (4B and 5B are classifications in ASTM D3359-97, in which 4B is less than 5% of coated area removed and 5B is none of area removed).

### Example 2. First Comparative Example (Prepared as Described in U.S. Pat. No. 8,512,722)

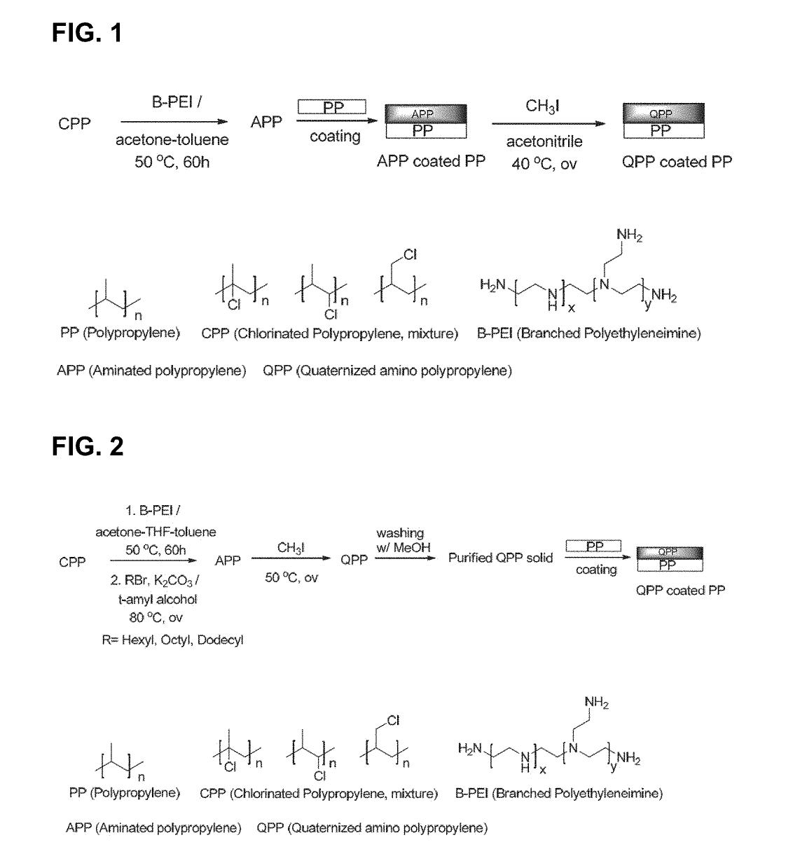

A sample material was prepared according to Scheme 1 (FIG. 1). Thus, chlorinated polypropylene (CPP; ca. 26% Chlorine content, Mw ca. 100,000, purchased from Aldrich) was dissolved in toluene at ca. 100° C. (5 wt % solution). Polypropylene sheet (PP; thickness of 1/16″, purchased from MSC Industrial Supply) was sliced into small pieces (1 cm×1 cm), followed by washing with methanol and deionized water to remove impurities on the surface. The surface of polypropylene was carefully coated with 5 wt % CPP solution and dried overnight at ambient temperature under air. The resulting CPP/PP piece was placed into vial, followed by adding 1 mL per piece of 1 wt % polyethyleneimine solution (PEI; Mw ca. 423, purchased from Aldrich and dissolved in acetone or acetonitrile). The mixture was stirred overnight at ca. 60° C., then the piece was taken out from vial and rinsed with acetone and deionized water. This aminated polypropylene (PP) piece (APP/PP) was immersed in a mixture of ethyl bromide (6 wt % solution in acetone or acetonitrile) and triethylamine (0.1 mL per piece). After reaction at ca. 40° C. for 24 h, the piece was washed with deionized water and acetone. The density of quaternary ammonium groups on the surface was measured by a colorimetric method based on fluorescent complexation and UV-Vis spectroscopy.

### Example 3. Elemental Analysis of QPP Coated Polypropylene Surface

### Example 3.1. Method

X-ray photoelectron spectroscopy (XPS) was performed on QPP-coated substrates (polypropylene substrate and silicon wafer substrate) to assess the presence and nature of bonded nitrogen, chlorine, iodine and bromine. XPS measures were performed using a Kratos Axis Ultra DLD X-ray photoelectron spectrometer (XPS) equipped with a magnetic immersion lens and charge neutralization system with the spherical mirror and concentric hemispherical analyzers with the choice of either a Mg or Al anodes for high-sensitivity surface analysis. The instrument has a typical sampling depth of 2-10 nm and detection limit around 1 ppt (varies depending on element of interest).

Four samples were loaded simultaneously for analysis, and the system was pumped down to <1.0×10⁻⁷ Torr prior to measuring. Sample height was adjusted using a custom laser range finder to establish appropriate working distance. A survey scan was first performed to evaluate counts and to get a preliminary assessment of the scan characteristics. The beam energy was subsequently set to 10 mA and 15 kV. Following the survey scan, slow scans were performed in the binding energy ranges for C₁ₛ, I_{3d}, Br_{3d}, Cl₂ₚ, N₁ₛ. All peaks were calibrated with respect to the adventitious carbon peak (binding energy=284.8 eV). Binding energies were compared against those reported in the NIST SR Spectroscopy database (srdata.nist.gov).

### Example 3.2. Results

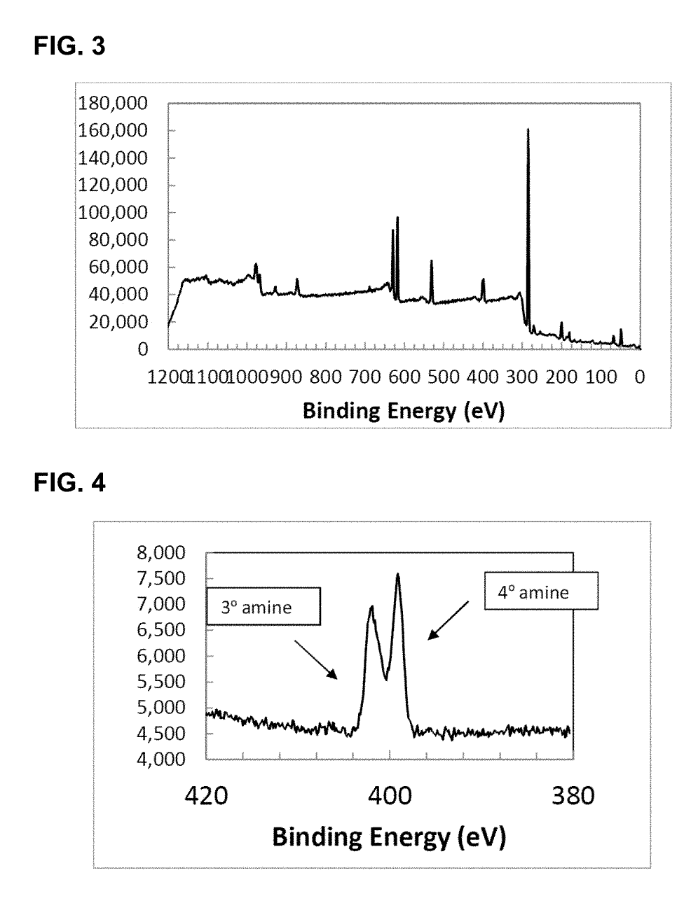

The results of XPS testing are shown in FIG. 3 and FIG. 4. The Nitrogen is spectrum yielded at least two distinct peaks (398.9 eV, 402.1 eV) which are similar to published binding energy values for tertiary (398.7 eV) and quaternary (401.0 eV and 401.8 eV) species in the coating. See Adina Haimov, et al., “Alkylated Polyethyleneimine/Polyoxometalate Synzymes as Catalysts for the Oxidation of Hydrophobic Substrates in Water with Hydrogen Peroxide,” J. Am. Chem. Soc. 2004, 126, 11762-11763 for methods and binding energies.

These elemently analysis of the quaternary amino polypropylene confirmed that the samples contained 5.5% of amine group in which chloride of starting polymer was replaced by amine of polyethyleneimine

### Example 4. Surface Densities of the Quaternary Amine (DQA) of the QPP-Coated Polypropylene

The amount of the quaternized amine in the surface coating was characterized according to the procedure described in Huang et al., “Antibacterial Polypropylene via Surface-Initiated Atom Transfer Radical Polymerization,” Biomacromolecules 2007, 8, 1396-1399, which is incorporated by reference herein at least for this methodology. The results are provided in Table 1 for six samples and one comparative example.

TABLE 1
Density of quaternized amine (DQA) on the surface
of the spray-coated polypropylene

| Sample # | R-Br (alkylation) | R-X (quaternization) | DQA (×10¹⁶) |
|---|---|---|---|
| 1 | bromohexane | Iodomethane | 6.61 |
| 2 | Bromooctane | Iodomethane | 3.91 |
| 3 | Bromododecane | Iodomethane | 16.9 |
| 4 | Bromohexane | Benzyl bromide | 0.13 |
| 5 | Bromooctane | Benzyl bromide | 0.12 |
| 6 | Bromododecane | Benzyl bromide | 0.29 |
| 7* | None | Iodomethane | 7.51 |

*Sample 7 was prepared by method of U.S. Pat. No. 8,512,722 (Example 2) (dip-coated)

### Example 5. Antimicrobial Assay of the QPP-Coated Polypropylene

The QPP spray coated polypropylene samples were tested for antimicrobial inhibition against the G(+) bacteria, Staphylococcus aureus, and the G(−) bacteria, Pseudomonas aeruginosa, using a bio-assay protocol based on ISO 22196. The test samples were prepared as circular films having an area of 572 mm² and placed in sterile Petri dishes. An overnight culture of the bacteria was diluted directly into 1:500 NTB (NTB is NeuroTrace Blue staining agent from Invitrogen). Test inoculum (0.3 mL) was added to each carrier and a sterile film was placed over the inoculum to facilitate spreading. Carriers we incubated for 24 hours, than neutralized in 10 mL of DE broth (i.e., Dey-Engley Neutralizing broth). Standard plating and enumeration techniques were used to determine percent and log reduction. Results are summarized in Table 2.

TABLE 2
Antimicrobial Inhibition on QPP Coated Polypropylene

| | | | | Percent | |
|---|---|---|---|---|---|
| Test | Time | | | Reduction (vs. | Log Reduction |
| Microorganism | (hour) | Sample | CFU/Carrier | Control) | (vs. Control) |
| S. aureus | 0 | Control | 5 × 10⁵ | NA | |
| ATCC 6538 | 24 | Control | 2.35 × 10⁶ | | |
| | | (PP) | | | |
| | 24 | 1 | <5.00 | >99.99978% | >5.67 |
| | 24 | 7* | <5.00 | >99.99978% | >5.67 |
| P. aeruginosa | 0 | Control | 7.50 × 10⁵ | NA | |
| ATCC 9027 | 24 | Control | 1.5 × 10⁷ | | |
| | | (PP) | | | |
| | 24 | 1 | 20.0 | >99.9999% | 5.87 |
| | 24 | 7* | <5.00 | >99.99997% | >6.48 |

*Sample 7 was prepared by method of U.S. Pat. No. 8,512,722 (Example 2)

### Example 6. Methods

Unless otherwise stated, the testing was done according to the methods provided in U.S. Pat. No. 8,512,722, which is incorporated by reference herein in its entirety or at least for this purpose. For the sake of completeness, these are repeated in part here.

Study Design: Squares of control and coated samples were exposed to suspensions of Pseudomonas aeruginosa and Staphylococcus aureus to determine if growth was inhibited and if the organisms were killed. The effect of the coatings on the bacteria was compared to control squares.

Test for Inhibition: 24 hour broth cultures of P. aeruginosa and S. aureus were prepared in tryptic soy broth. The suspensions were adjusted to concentrations of 10⁵ orgs/ml. One ml of broth was added to each well in a tray. The tray was incubated for 18 hours at 35° C. The wells were examined for turbidity as indicating growth. Growth indicated lack of inhibitory activity.

Test for Cidal Activity: Every well was subcultured to a blood agar plate, and the plates were incubated for 18-24 hours at 35° C. Colonies were counted. Growth indicated a lack of cidal action.

Test for Residual Activity: Immediately after the plates were subcultured and all broth had been removed from each well, sterile tryptic soy broth was added to the wells, and the well was incubated again at 18 hours at 35° C. The wells were examined for growth. Growth indicated lack of residual anti-bacterial activity.

As those skilled in the art will appreciate, numerous modifications and variations of the present disclosure are possible in light of these teachings, and all such are contemplated hereby. Similarly, it will be appreciated that any described material, feature, or article may be used in combination with any other material, feature, or article, and such combinations are considered within the scope of this disclosure.

The disclosures of each patent, patent application, and publication cited or described in this document are hereby incorporated herein by reference, each in its entirety, for all purposes, or for at least the context in which it is cited herein.

What is claimed:

1. A method for forming an anti-microbial surface coating on a substrate, the method comprising:
a) reacting a polymeric pre-amine material comprising a plurality of the functional groups, with a polymeric amine-containing reagent, comprising poly(ethyleneimine), so as to convert at least a portion of the functional groups to amine groups to form a composite polyamine polymer;
b) step-wise reacting the composite polyamine polymer with:
(i) a first alkyl halide, R—X, where R is a C₆₋₁₈ alkyl group and X is Br or I, and
(ii) a second alkyl halide that is more electrophilic than the first alkyl halide,
so as to convert at least a portion of the amine groups of the composite polyamine polymer to quaternary amine groups, the stepwise reaction resulting in the formation of a mixture of quaternized composite polyamine polymer and quaternized alkylpoly(ethyleneimine);
c) optionally removing the quaternized alkylpoly(ethyleneimine) from the quaternized composite polyamine polymer;
d) dissolving the quaternized composite polyamine polymer in an organic solvent to form a solution of the quaternized composite polyamine polymer; and
e) applying the solution of the quaternized composite polyamine polymer to the substrate and removing the organic solvent, such that the substrate is coated with the quaternized composite polyamine polymer.

2. The method of claim 1, wherein the polymeric pre-amine material is a polyhalogenated polymer.

3. The method of claim 1, wherein the polymeric pre-amine material is chlorinated polypropylene.

4. The method of claim 1, wherein the poly(ethyleneimine) is a linear poly(ethyleneimine) comprising secondary amines.

5. The method of claim 1, wherein the poly(ethyleneimine) is a branched poly(ethyleneimine) comprising primary, secondary, and tertiary amines.

6. The method of claim 1, wherein the poly(ethyleneimine) has a molecular weight in the range of 350 Daltons to 1,000,000 Daltons.

7. The method of claim 1, wherein the the reaction of the composite pre-amine polymer with the first alkyl halide is done in the presence of base.

8. The method of claim 1, wherein the first alkyl halide is an alkyl bromide (X═Br).

9. The method of claim 1, wherein the product of the reaction between the composite pre-amine polymer and the first alkyl halide is isolated before the further reaction with the second alkyl halide.

10. The method of claim 1, wherein the second alkyl halide is methyl iodide, methyl bromide, benzyl iodide, or benzyl bromide.

11. The method of claim 1, wherein the quaternized alkylpoly(ethyleneimine) is removed from the mixture of quaternized composite polyamine polymer and quaternized alkylpoly(ethyleneimine) prior to dissolving the quaternized composite polyamine polymer in the organic solvent.

12. The method of claim 11, wherein the quaternized alkylpoly(ethyleneimine) is removed from the quaternized composite polyamine polymer by washing a solid mixture of the quaternized alkylpoly(ethyleneimine) and the quaternized composite polyamine polymer with solvent comprising water and/or a C₁₋₃ alcohol.

13. The method of claim 12, wherein the resulting quaternized composite polyamine polymer is substantially free of the quaternized alkylpoly(ethyleneimine).

14. The method of claim 1, wherein the organic solvent used in the solution of the quaternized composite polyamine polymer of step (d) comprises one or more of an aromatic hydrocarbon, a halogenated solvent, or a C₁₋₆ alcohol.

15. The method of claim 14, wherein the organic solvent comprises one or more of toluene, dichloromethane, methanol, or ethanol.

16. The method of claim 1, wherein the substrate is an organic polymer.

17. The method of claim 1, wherein the solution of the quaternized composite polyamine polymer is applied to the substrate by brush coating, dip coating, spin coating, or spray coating,

18. A composition comprising a quaternized composite polyamine polymer prepared by:
a) reacting a polymeric pre-amine material comprising a plurality of the functional groups, with a polymeric amine-containing reagent, comprising poly(ethyleneimine), so as to convert at least a portion of the functional groups to amine groups to form a composite polyamine polymer;
b) step-wise reacting the composite polyamine polymer with
(i) a first alkyl halide, R—X, where R is a C₆₋₁₈ alkyl group and X is Br or I, and
(ii) a second alkyl halide that is more electrophilic than the first alkyl halide,
so as to convert at least a portion of the amine groups of the composite polyamine polymer to quaternary amine groups, the stepwise reaction resulting in the formation of a mixture of quaternized composite polyamine polymer and quaternized alkylpoly(ethyleneimine);
c) removing the quaternized alkylpoly(ethyleneimine) from the quaternized composite polyamine polymer.

19. A solution comprising the quaternized composite polyamine polymer of claim 18 dissolved in an organic solvent

20. A coating layer prepared by the method of claim 1 that exhibits anti-microbial activity.

21. A coated substrate prepared by the method of claim 1 that exhibits anti-microbial activity.

22. A coating layer comprising a quaternized composite polyamine polymer:
the composite polyamine polymer prepared by the reaction between a polymeric pre-amine material comprising a plurality of the functional groups, with a polymeric amine-containing reagent comprising poly(ethyleneimine), such that at least a portion of the functional groups of the polymeric pre-amine material have been converted to amine groups;
wherein at least a portion of the converted amine groups are quaternized by a first alkyl halide, R—X, where R is a C₆₋₁₈ alkyl group and X is Br or I;
the coating layer exhibiting anti-microbial activity.

23. The coating layer of claim 22, wherein the quaternized composite polyamine polymer is substantially free of a corresponding quaternized free poly(ethyleneimine).

24. A coated substrate comprising a coating layer of claim 22 that exhibits anti-microbial activity.

25. The coated substrate of claim 22, wherein the substrate is an organic polymer, preferably polypropylene.

26. The coated substrate of claim 22, wherein the quaternized composite polyamine polymer is non-covalently bonded to the substrate.

27. The coated substrate of claim 26, wherein the quaternized composite polyamine, wherein the coating is bonded to the substrate via hydrogen bonding, Van der Waals forces, ionic bonding or a combination thereof.
